(19) United States
(12) Patent Application Publication
(10) Pub. No.: US 2004/0234667 A1
(43) Pub. Date: Nov. 25, 2004

(54) Release agent and method for use in baking applications

(76) Inventor: Dennis Richard Jennings, Kwa-Zulu Natal (ZA)

Correspondence Address: Pennington, Moore, Wilkinson, Bell & Dunbar, P.A., Post Office Box 10095, Tallahassee, FL, 32302-2095, US

(21) Appl. No.: 10/620,678

(22) Filed: Jul. 16, 2003

(30) Foreign Application Priority Data
Jul. 19, 2002 (ZA) 2002/5796

(51) Int. Cl. A23D 7/00

(52) U.S. Cl. 426/601

(57) ABSTRACT

A release agent suitable for use in the baking industry. It includes an emulsion made from a food grade mineral oil, water, and an emulsifying agent. A vegetable oil may be optionally added. Suitable mineral oils include white oil and polydimethylsiloxane (“silicone oil”). Suitable vegetable oils include soybean oil, corn oil, sunflower oil, olive oil, peanut oil, safflower oil, cottonseed oil, and palm oil. The release agent can be made in a concentrated form suitable for dilution prior to use. Methods for making the release agent are disclosed. Methods for applying the release agent in the baking process are also disclosed. The use of the proposed release agent results in substantially less carbon fouling on the baking pans.

### CROSS-REFERENCES TO RELATED APPLICATIONS

Pursuant to 37 C.F.R. §1.55, this non-provisional U.S. patent application claims the benefit of a previously filed South African patent application. The prior South African patent application was filed on 19 Jul., 2002. It was assigned South African Serial No. 2002/5796. The priority claim is made on the basis of the Paris Convention for the Protection of Industrial Property (613 O.G. 23, 53 Stat. 1748). A certified copy of the South African application is being filed herewith.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of baking. More specifically, the invention comprises a composition for releasing baked products from baking pans, along with methods for making and applying the composition.

2. Description of the Related Art

Industrial baking operations involve the repeated use of a set of baking pans. These pans may go through many baking cycles per day. Release agents have been used for many years to enable the easy extraction of the bread from the pans.

Release agents have typically been sprayed on the pans prior to the addition of the dough. Such agents must obviously be edible, and must not impart undesirable flavors or colors to the finished product. Edible oils, typically vegetable oils, have been used in this role for many years. Examples are soybean oil, corn oil, sunflower oil, olive oil, peanut oil, safflower oil, cottonseed oil, and palm oil. Glycerides, as well as other animal fat derivatives, are often included. Because these prior art formulations are typically sprayed, an aerosol or carrier constituent may be used.

The prior art formulations contain a significant amount of carbon. Residual carbon tends to accumulate on the pans over the baking cycles. This carbon fouling becomes a significant problem, as it is quite difficult to remove. One solution is simply to discard a set of pans. As several hundred or several thousand pans may comprise the set, this solution is unsatisfactory. A second solution is to pull the pans out of service and clean them. Those skilled in the art will know that removing carbon deposits from metal objects is exceeding difficult. It often necessitates the use of toxic chemicals, such as carbon tetrachloride. Such cleaning operations must generally be conducted in a separate facility equipped to handle such chemicals. Thus, the pan set must be shipped away and taken out of service for days if not weeks. This fact necessitates the use of two or three pan sets for a single baking line. The use of carbon-depositing pan release agents is therefore problematic.

### BRIEF SUMMARY OF THE INVENTION

The present invention comprises a release agent suitable for use in the baking industry. It includes an emulsion made from a food grade mineral oil, water, and an emulsifying agent. A vegetable oil may be optionally added. Suitable mineral oils include white oil and polydimethylsiloxane (“silicone oil”). Suitable vegetable oils include soybean oil, corn oil, sunflower oil, olive oil, peanut oil, safflower oil, cottonseed oil, and palm oil. The release agent can be made in a concentrated form suitable for dilution prior to use. Methods for making the release agent are disclosed. Methods for applying the release agent in the baking process are also disclosed. The use of the proposed release agent results in substantially less carbon fouling on the baking pans.

### BRIEF DESCRIPTION OF THE SEVERAL VIEWS OF THE DRAWINGS

FIG. 1 is a perspective view, showing one method of applying the present invention.

### REFERENCE NUMERALS IN THE DRAWINGS

| | | | |
|---|---|---|---|
| 10 | conveyor belt | 12 | dispensing manifold |
| 14 | nozzle | 16 | output line |
| 18 | input line | 20 | controller |

### DETAILED DESCRIPTION OF THE INVENTION

The present invention can be applied as a release agent in numerous applications. For purposes of providing specific examples, the bread baking industry will be used. However, the reader should bear in mind that the invention is by no means limited to this specific application.

The present release agent is fundamentally an emulsion of food grade mineral oil in water. An emulsifying agent is used to assist in the formation of the emulsion, as well as stabilizing the emulsion so that the release agent can be stored for extended periods. The release agent is formed by heating the food grade mineral oil to a temperature of about 100° C. to about 130° C., then adding boiling water. A suitable emulsifier can be added as well. Mechanical agitation during the addition of the water to the oil may also be used. Mixing the constituents at a controlled rate may be desirable. The resulting emulsion is allowed to cool to room temperature. It can then be placed in containers for storage.

Suitable food grade mineral oils include white oil and silicone oil (polydimethylsiloxane). While many prior art emulsifiers can be used, one particularly suitable emulsifier is sorbitan monostearate. Other suitable emulsifiers include ETOCAS 40 and CRILL 3.

Industrial baking contemplates the use of large volumes of release agent. Thus, it is desirable to provide the release agent in concentrated form in order to minimize shipping costs. The concentrated form can be shipped to the baking facility. It is then diluted by adding a considerable volume of additional water prior to use. The concentrate is preferably formulated so that only additional water is needed to create the diluted form.

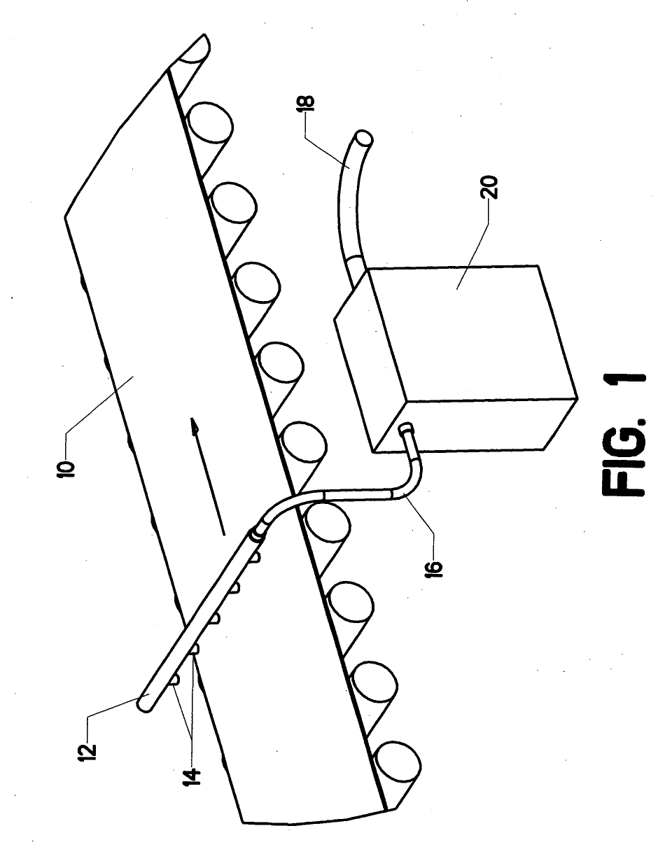

The present release agent can be sprayed on the baking pans as for the prior art release agents. However, because it does not tend to form any significant gummy residue, it can also be applied by other methods. As one example, it can be applied to the belt which carries the bread dough to the baking pans. FIG. 1 is a simplified representation of this process. Conveyor belt 10 moves in the direction indicated by the arrow. Bread dough is transported by this conveyor belt. Input line 18 is connected to a supply of the diluted release agent. Controller 20 regulates the flow of release agent. It supplies the appropriate amount of release agent through output line 16 to dispensing manifold 12. Dispensing manifold 12 mounts a series of nozzles 14, which are directed toward conveyor belt 10.

Controller 20 can assume many forms. In the modern industrial context, it is likely to be a programmable logic controller running software directing its activity. It can be set to regulate the flow of release agent according to the throughput of dough, as well as other conditions such as temperature, humidity, etc. At the appropriate interval, it switches on the flow of release agent. An appropriate volume is then sprayed onto conveyor belt 10. A the dough moves along the conveyor, the release agent tends to coat the external surfaces of the dough. The dough is then deposited in the baking pans with the release agent already applied. Thus, there is no need to coat the pans themselves.

This skilled in the art will realize that the apparatus shown in FIG. 1 can be configured to apply the release agent in many ways. As a second example, optical sensors could be used to sense the passage of bread dough beneath dispensing manifold 12. The release agent could then be sprayed directly on the dough itself.

Spray nozzles are only one convenient known method of application. A higher viscosity (i.e., more concentrated) version of the release agent could be controllably dripped onto the belt or the dough itself Thus, the actual application hardware is not critical.

The release agent has some mild adhesive properties. This can be useful for affixing supplementary edible objects to the bread dough, such as sesame seeds, wheat grains, and the like. Thus, once the dough is deposited in the pans—or even before—a secondary operation can add the supplementary edible objects.

Specific formulations of the proposed release agent will now be discussed in detail.

### EXAMPLE 1

A concentrated formulation was created by heating silicone oil (polydimethysiloxane) to between 100° C. and 130° C. Boiling water was then added, while the temperature of the mixture was maintained between 100° C. and 130° C. Sorbitan monostearate was added as an emulsifying agent. Mechanical agitation was used to more rapidly create a uniform emulsion. The constituents of the concentrated formula, stated on the basis of percentage of total volume, were as follows:

| | |
|---|---|
| Silicone oil | 19% |
| Sorbitan monostearate | 1-2% |
| Water | 79-81% |

A stable emulsion was formed that could be stored at ambient temperature for an extended period. The concentrated formulation contains enough emulsifier to permit the addition of diluting water without destabilizing the emulsion. Thus, in this example, approximately four parts of additional water were added to each original part of water to create a diluted form which is then ready for application (using optional mechanical agitation). The constituents of the diluted formula, stated on the basis of percentage of total volume, were as follows:

| | |
|---|---|
| Silicone oil | 4% |
| Sorbitan monostearate | .2-.5% |
| Water | 91-96% |

This diluted formula was effective as a pan release agent, while producing greatly reduced residue in the pans. The dilution can be carried out under ambient conditions.

### EXAMPLE 2

A concentrated formulation was created by heating silicone oil (polydimethysiloxane) to between 100° C. and 130° C. Boiling water was then added, while the temperature of the mixture was maintained between 100° C and 130° C. Sorbitan monostearate was added as an emulsifying agent. Mechanical agitation was used to more rapidly create a uniform emulsion. The constituents of the concentrated formula, stated on the basis of percentage of total volume, were as follows:

| | |
|---|---|
| Silicone oil | 32% |
| Sorbitan monostearate | 1-2% |
| Water | 64-65% |

A stable emulsion was again formed. A diluted formula was then created having the following constituents, stated on the basis of percentage of total volume:

| | |
|---|---|
| Silicone oil | 6.7% |
| Sorbitan monostearate | .2-.5% |
| Water | 92-93% |

This diluted formula was likewise effective as a pan release agent.

### EXAMPLE 3

Certain vegetable oil coatings have traditionally been used to form a desirable crust on the surface of the baked bread (as well as desirable colors, flavors, etc.). As described previously, these vegetable oils, if used in quantities sufficient to act as a pan release agent, tend to cause carbon fouling in the pans. However, such oils can be added to the present release agent in much lower amounts in order to provide the desired bread characteristics without substantial fouling. One such desirable vegetable oil (among many candidates) is sunflower oil. Accordingly, a concentrated formulation was created having the following formula, stated on the basis of percentage of total mass:

| | |
|---|---|
| Silicone oil | 20.7% |
| Sunflower oil | 8.3% |
| Emulsifier | 1.2% |
| Water | 69.8% |

A diluted formulation was then created, having the following formula on the basis of percentage of total mass:

| | |
|---|---|
| Silicone oil | 5.5% |
| Sunflower oil | 2.2% |
| Emulsifier | .3% |
| Water | 92% |

This formulation was effective as a low-residue pan release agent, while imparting the desired characteristics to the baked bread.

### EXAMPLE 4

In some instances it may be desirable to use two or more emulsifiers. One emulsifier may be particularly suitable for use in water while a second emulsifier may be particularly suitable for use in the Silicone oil. A set of such emulsifiers was used to create another formulation. Water and the “water emulsifier” were mixed and heated to the boiling point. Silicone oil and the “oil emulsifier” were mixed and heated to a temperature marginally higher than the boiling point of water. The two mixtures were then mixed with one another, including mechanical agitation. A resulting concentrated formulation was created as follows:

| | | |
|---|---|---|
| Water | 110 | liters |
| Silicone oil | 30 | liters |
| Water and oil emulsifiers | 3.5 | kg |
| Vegetable oil | 10 | liters |

Using emulsifiers with a typical specific gravity in the range of 1.1 to 1.3, the concentrated formulation can be restated as follows:

| | |
|---|---|
| Water | 110 liters (72%) |
| Silicone oil | 30 liters (20%) |
| Water and oil emulsifiers | 2.77 liters (2%) |
| Vegetable oil | 10 liters (6%) |

The particular vegetable oil used was Sunflower oil. A diluted formulation was then created by adding approximately 3 to 5 parts water for each part water in the concentrated formulation.

Numerous other formulations are possible. It was generally observed that as to the concentrated formula, the food grade mineral oil should comprise between about 15% to about 25% of the total by volume. The water should comprise about 70% to about 85% of the total volume, while the emulsifier should comprise about 0.1% to about 5% of the total volume.

As to the diluted version, the food grade mineral oil should comprise between about 2% to about 6% of the total volume. The water should comprise about 89% to about 97% of the total volume, while the emulsifier should comprise about 0.1% to about 5% of the total volume. If a vegetable oil is added, it will generally take the place of a portion of the food grade mineral oil.

Those skilled in the art will know that different types of food grade mineral oils could be mixed to form a suitable composition. As an example, white oil could be substituted for a portion ofthe silicone oil and vice-versa. Those skilled in the art will also know that many different vegetable oils could potentially be used in the formulation, including soybean oil, corn oil, olive oil, peanut oil, safflower oil, cottonseed oil, and palm oil. Many different known emulsifiers could also be used.

Water is obviously the cheapest ingredient in the present formulation. It is therefore desirable to experiment with the dilution of the concentrated formula to find the optimum performance for each bakery line. The bakeries adopting the present invention will likely be converting from vegetable emulsion release agents. Such a conversion can be experimentally made as follows:

Stage 1—Use concentrated food grade mineral oil formula.

Stage 2—Dilute with one part water for each part water in concentrate.

Stage 3—Dilute with two parts water for each part water in concentrate.

Stage 4—Dilute with three parts water for each part water in concentrate.

Stage 5—Dilute with four parts water for each part water in concentrate.

Testing is conducted at each stage to determine if the bread sticks to the pans. If any sticking occurs, then the operator must revert to the prior stage. In this fashion, the bakery operator can find just the right dilution level. Maximum permissible dilution is desirable from the standpoint of minimizing release agent cost and from the standpoint of minimizing residue. The less concentrated formulations obviously produce less residue.

Although the preceding description contains considerable detail, it should not be viewed as limiting the present invention but rather as providing examples of the preferred embodiments. As an example, the specific percentages given for the formulae could be varied anywhere within the broad ranges described. Thus, the scope of the present invention should be fixed by the following claims rather than by the specific examples presented.

Having described my invention, I claim:

1. A release agent, comprising:
a. food grade mineral oil;
b. water; and
c. an emulsifier, in a quantity sufficient to form an emulsion between said food grade mineral oil and said water.

2. A release agent as recited in claim 1, wherein said food grade mineral oil is white oil.

3. A release agent as recited in claim 1, wherein said food grade mineral oil is polydimethylsiloxane.

4. A release agent as recited in claim 2, wherein said emulsifier is sorbitan monostearate.

5. A release agent as recited in claim 3, wherein said emulsifier is sorbitan monostearate.

6. A release agent as recited in claim 1, further comprising vegetable oil.

7. A release agent as recited in claim 6, wherein said vegetable oil is selected from the group comprising: sunflower oil, soybean oil, corn oil, olive oil, peanut oil, safflower oil, cottonseed oil, and palm oil.

8. A release agent as recited in claim 2, further comprising vegetable oil.

9. A release agent as recited in claim 8, wherein said vegetable oil is selected from the group comprising: sunflower oil, soybean oil, corn oil, olive oil, peanut oil, safflower oil, cottonseed oil, and palm oil.

10. A release agent as recited in claim 3, further comprising vegetable oil.

11. A release agent as recited in claim 10, wherein said vegetable oil is selected from the group comprising: sunflower oil, soybean oil, corn oil, olive oil, peanut oil, safflower oil, cottonseed oil, and palm oil.

12. A release agent as recited in claim 4, further comprising vegetable oil.

13. A release agent as recited in claim 12, wherein said vegetable oil is selected from the group comprising: sunflower oil, soybean oil, corn oil, olive oil, peanut oil, safflower oil, cottonseed oil, and palm oil.

14. A release agent as recited in claim 5, further comprising vegetable oil.

15. A release agent as recited in claim 14, wherein said vegetable oil is selected from the group comprising: sunflower oil, soybean oil, corn oil, olive oil, peanut oil, safflower oil, cottonseed oil, and palm oil.

16. A release agent, comprising:
a. food grade mineral oil, wherein the volume of said food grade mineral oil is in the range of about 15% to about 25% of the total volume of said release agent;
b. water, wherein the volume of said water is in the range of about 70% to about 85% of the total volume of said release agent; and
c. an emulsifier, wherein the volume of said emulsifier is in the range of about 0.1% to about 5% of the total volume of said release agent.

17. A release agent as recited in claim 16, wherein said release agent is diluted by adding additional water so that said release agent comprises:
a. food grade mineral oil, wherein the volume of said food grade mineral oil is in the range of about 2% to about 6% of the total volume of said release agent;
b. water, wherein the volume of said water is in the range of about 89% to about 97% of the total volume of said release agent; and
c. an emulsifier, wherein the volume of said emulsifier is in the range of about 0.1% to about 5% of the total volume of said release agent.

18. A release agent, comprising:
a. food grade mineral oil, wherein the volume of said food grade mineral oil is in the range of about 25% to about 35% of the total volume of said release agent;
b. water, wherein the volume of said water is in the range of about 60% to about 75% of the total volume of said release agent; and
c. an emulsifier, wherein the volume of said emulsifier is in the range of about 0.1% to about 5% of the total volume of said release agent.

19. A release agent as recited in claim 18, wherein said release agent is diluted by adding additional water so that said release agent comprises:
a. food grade mineral oil, wherein the volume of said food grade mineral oil is in the range of about 5% to about 7% of the total volume of said release agent;
b. water, wherein the volume of said water is in the range of about 88% to about 94% of the total volume of said release agent; and
c. an emulsifier, wherein the volume of said emulsifier is in the range of about 0.1% to about 5% of the total volume of said release agent.

20. A release agent, comprising:
a. polydimethylsiloxane, wherein the mass of said polydimethylsiloxane is in the range of about 15% to about 25% of the total mass of said release agent;
b. sunflower oil, wherein the mass of said sunflower oil is in the range of about 5% to about 10% of the total mass of said release agent;
c. an emulsifier, wherein the mass of said emulsifier is in the range of about 0.5% to about 2% of the total mass of said release agent; and
d. water, wherein the mass of said water is in the range of about 63% to about 79% of the total mass of said release agent.

21. A release agent as recited in claim 20, wherein said release agent is diluted by adding additional water, so that said release agent comprises:
a. polydimethylsiloxane, wherein the mass of said polydimethylsiloxane is in the range of about 4% to about 7% of the total mass of said release agent;
b. sunflower oil, wherein the mass of said sunflower oil is in the range of about 1% to about 3% of the total mass of said release agent;
c. an emulsifier, wherein the mass of said emulsifier is in the range of about 0.1% to about 0.5% of the total mass of said release agent; and
d. water, wherein the mass of said water is in the range of about 89% to about 95% of the total mass of said release agent.
b. water, wherein the volume of said water is in the range of about 60% to about 75% of the total volume of said release agent; and
c. an emulsifier, wherein the volume of said emulsifier is in the range of about 0.1% to about 5% of the total volume of said release agent.

22. A release agent, comprising:
a. polydimethylsiloxane, wherein the mass of said polydimethylsiloxane is in the range of about 15% to about 25% of the total mass of said release agent;
b. sunflower oil, wherein the mass of said sunflower oil is in the range of about 5% to about 10% of the total mass of said release agent;
c. a first emulsifier, suitable for minxing with water, wherein the mass of said emulsifier is in the range of about 0.5% to about 2% of the total mass of said release agent;
d. a second emulsifier, suitable for mixing with polydimethylsiloxane, wherein the mass of said emulsifier is in the range of about 0.5% to about 2% of the total mass of said release agent; and
e. water, wherein the mass of said water is in the range of about 63% to about 79% of the total mass of said release agent.

23. A release agent as recited in claim 22, wherein said release agent is diluted by adding additional water, so that said release agent comprises:
a. polydimethylsiloxane, wherein the mass of said polydimethylsiloxane is in the range of about 4% to about 7% of the total mass of said release agent;
b. sunflower oil, wherein the mass of said sunflower oil is in the range of about 1% to about 3% of the total mass of said release agent;
c. a first emulsifier, suitable for mixing with water, wherein the mass of said emulsifier is in the range of about 0.1% to about 0.5% of the total mass of said release agent;
d. a second emulsifier, suitable for mixing with polydimethylsiloxane, wherein the mass of said emulsifier is in the range of about 0.1% to about 0.5% of the total mass of said release agent; and
e. water, wherein the mass of said water is in the range of about 89/o to about 95% of the total mass of said release agent.

24. A method for making a release agent, comprising:
a. heating silicone oil to a temperature between 100° C. and 130° C.;
b. adding boiling water to said silicone oil, to form a first mixture; and
c. adding an emulsifier to said first mixture to form a second mixture.

25. A method as recited in claim 24, wherein said emulsifier is sorbitan monostearate.

26. A method as recited in claim 24, wherein:
a. said silicone oil comprises about 19% of the total volume of said release agent;
b. said emulsifier comprises between about 1% and about 2% ofthe total volume of said release agent; and
c. said water comprises between about 79% and about 81% of the total volume of said release agent.

27. A method as recited in claim 26, wherein:
a. additional water is added so that said water comprises between about 91% and about 96% of the total volume of said release agent;
b. said silicone oil comprises about 4% of the total volume of said release agent; and
c. said emulsifier comprises between about 0.2% and about 0.5% of the total volume of said release agent.

28. A method as recited in claim 24, wherein:
a. said silicone oil comprises about 32% of the total volume of said release agent;
b. said emulsifier comprises between about 1% and about 2% ofthe total volume of said release agent; and
c. said water comprises between about 64% and about 65% of the total volume of said release agent.

29. A method as recited in claim 28, wherein:
a. additional water is added so that said water comprises between about 92% and about 93% of the total volume of said release agent;
b. said silicone oil comprises about 6.7% of the total volume of said release agent; and
c. said emulsifier comprises between about 0.2% and about 0.5% of the total volume of said release agent.

30. A method as recited in claim 24, further comprising adding a vegetable oil to form a third mixture.

31. A method as recited in claim 30, wherein:
a. said silicone oil comprises about 21% of the total volume of said release agent;
b. said vegetable oil comprises about 8% of the total volume of said release agent;
c. said emulsifier comprises about 1% of the total volume of said release agent; and
c. said water comprises between about 70% of the total volume of said release agent.

32. A method as recited in claim 31, wherein:
a. additional water is added so that said water comprises about 92% of the total volume of said release agent;
b. said silicone oil comprises about 5% of the total volume of said release agent;
c. said vegetable oil comprises about 2% of the total volume of said release agent; and
d. said emulsifier comprises about 0.3% of the total volume of said release agent.

33. A method as recited in claim 30, wherein said vegetable oil is is selected from the group comprising: sunflower oil, soybean oil, corn oil, olive oil, peanut oil, safflower oil, cottonseed oil, and palm oil.

34. A method as recited in claim 24, wherein:
a. said silicone oil comprises between about 15% and about 25% of the total volume of said release agent;
b. said emulsifier comprises between about 0.1% and about 5% ofthe total volume of said release agent; and
c. said water comprises between about 70% and about 85% of the total volume of said release agent.

35. A method as recited in claim 34, wherein:
a. additional water is added so that said water comprises between about 89% and about 97% of the total volume of said release agent;
b. said silicone oil comprises between about 2% and about 6% of the total volume of said release agent; and
c. said emulsifier comprises between about 0.1% and about 5% ofthe total volume of said release agent.

36. A method as recited in claim 30, wherein:
a. said silicone oil comprises between about 15% and about 25% of the total volume of said release agent;
b. said vegetable oil comprises between about 6% and about 10% of the total volume of said release agent;
c. said emulsifier comprises between about. 1% and about 5% of the total volume of said release agent; and
d. said water comprises between about 70% and about 85% of the total volume of said release agent.

37. A method as recited in claim 36, wherein:
a. additional water is added so that said water comprises between about 89% and about 97% of the total volume of said release agent;
b. said silicone oil comprises between about 2% and about 6% ofthe total volume of said release agent;
c. said vegetable oil comprises between about 1% and about 2% of the total volume of said release agent; and
d. said emulsifier comprises between about 0.1% and about 5% ofthe total volume of said release agent.

38. A method for making a release agent, comprising:
a. heating silicone oil to a temperature between 100° C. and 130C.;
b. adding a first emulsifier to said silicone oil to create a first mixture;
c. heating water to its boiling point;
d. adding a second emulsifier to said boiling water to create a second mixture; and
e. combining said first and second mixtures to create a third mixture.

39. A method as recited in claim 38, further comprising adding vegetable oil to said third mixture to form a fourth mixture.

40. A method as recited in claim 39, wherein said vegetable oil is selected from the group comprising: sunflower oil, soybean oil, corn oil, olive oil, peanut oil, safflower oil, cottonseed oil, and palm oil.

41. A method as recited in claim 39, wherein:
a. said silicone oil comprises about 20% of the total volume of said release agent;
b. said vegetable oil comprises about 6% of the total volume of said release agent;
c. said first and second emulsifiers in combination comprise about 2% of the total volume of said release agent; and
d. said water comprises about 72% of the total volume of said release agent.

42. A method as recited in claim 41, further comprising adding additional water to create a diluted formulation.
